(19) United States
(12) Patent Application Publication
(10) Pub. No.: US 2015/0095225 A1
(43) Pub. Date: Apr. 2, 2015

(54) ENABLING SYNCHRONIZATION BETWEEN DISPARATE PAYMENT ACCOUNT SYSTEMS

(71) Applicant: MasterCard International Incorporated, Purchase, NY (US)

(72) Inventors: Venu Appana, Edison, NJ (US); Maurice David Liscia, Long Island City, NY (US); Patrick Killian, Cottleville, MO (US)

(21) Appl. No.: 14/504,615

(22) Filed: Oct. 2, 2014

Related U.S. Application Data
(60) Provisional application No. 61/885,665, filed on Oct. 2, 2013.

(51) Int. Cl. G06Q 20/36; G06Q 20/40; G06Q 20/32

(52) U.S. Cl. CPC G06Q 20/3674; G06Q 20/3226; G06Q 20/4016
USPC 705/41

(57) ABSTRACT

Systems and methods that synchronize consumer accounts between disparate payment account systems. In some embodiments, a payment network receives an authorization request for a consumer transaction from a merchant acquirer processor including original payment credentials. The process includes transmitting a query to credential mapping database, receiving a response including a primary account number (PAN) and a multi-entity flag, transmitting the authorization request to an issuer financial institution (FI), receiving an approval response from the issuer FI. The process also includes routing the authorization request and the multi-entity flag to a payment gateway to forward to an appropriate stored value account (SVA) processor, receiving a disposition message indicating approval of the transaction by the SVA processor, and transmitting an authorization response to the merchant acquirer processor.

### CROSS-REFERENCE TO RELATED APPLICATIONS

The present application claims the benefit of U.S. Provisional Patent Application No. 61/885,665 entitled “Systems, Apparatus and Methods for Mobile Payment Gateway” filed on Oct. 2, 2013, the entire contents of which are incorporated herein by reference.

### FIELD OF THE INVENTION

The invention generally relates to systems and methods for enabling synchronization of consumer accounts between disparate payment account systems. In particular, methods, apparatus and systems are described that enable multi-lateral, real time synchronization between disparate payment account systems of record for multi-channel payments made by a consumer.

### BACKGROUND

Consumers are using mobile devices more and more, and the use of mobile telephones in particular is ubiquitous. In fact, in some countries it is common for consumers to utilize mobile telephones to communicate, to pay for goods and/or services, and to transfer funds between family members and/or friends. Thus, methods and apparatus have been developed to provide payment-enabled mobile devices to consumers for their use in making purchases and transferring money. However, some systems operate as closed loop systems wherein all the parties (customers, family members, friends, and merchants) in the system have accounts with a single payment services provider (PSP). In these closed-loop systems, a purchase or payment transaction involves direct transfers between the parties' accounts that are issued by the payment services provider. Therefore, payments can only be made between parties (such as a merchant and a consumer) who belong to the same closed loop system.

Thus, there is a need for systems, apparatus and processes to facilitate the safe, quick and reliable transfer by payment of money between consumers and merchants and/or family members and/or friends regardless of the types of payment system (closed loop or open loop) to which a consumer (payer) belongs. There is also a need for systems, apparatus and methods that allow communication between providers of a closed loop system such as a wallet provider and financial institutions (such as issuer processors) to allow improved interoperability.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram of a gateway transaction system in accordance with embodiments of the disclosure;

FIG. 2 is a block diagram of a gateway system pursuant to some embodiments of the disclosure;

FIG. 3 is a block diagram of a gateway system that accommodates multi-channel transactions by providing multi-lateral, real time synchronization of disparate payment account systems according to some embodiments of the disclosure;

FIG. 4 is a flow diagram of a consumer registration or enrollment process according to some embodiments of the disclosure;

FIG. 5 is a flowchart illustrating a gateway multi-channel transaction process in accordance with some embodiments of the disclosure; and

FIG. 6 is a block diagram of a payment gateway system according to an embodiment of the disclosure.

### DETAILED DESCRIPTION

In general, and for the purpose of introducing concepts of novel embodiments described herein, provided are systems, apparatus and methods for providing a gateway for messaging between one or more mobile wallet providers and one or more processors that process transactions on behalf of (“OBO”) financial account issuers. In some embodiments, systems, apparatus and methods enable multi-lateral, real time synchronization between disparate payment account systems of record for multi-channel payments made by a consumer.

Consumers are demanding the ability to seamlessly pay for purchases across multiple payment channels and using different types of payment instruments. This includes payment by phone, by plastic payment card (for example, credit card or debit card), by mobile device, and the like, that could be based on an open loop or a closed loop construct. The gateway systems, apparatus and methods described herein solve the technical problem of how to accomplish account balance synchronization across multiple payment entities that may utilize different authorization systems. In particular, consumer transactions that require such processing are flagged so that a gateway can facilitate the exchange of transaction information in real time between the appropriate entities. During such processing, if any entity involved in the transaction declines the payment authorization request then the entire transaction is declined.

Prior to a more detailed discussion of the novel aspects of such gateway systems and methods, several terms will be introduced that may be used herein for the purpose of illustrating features of some embodiments. As used herein, the term “mobile money” is used to refer to financial service offerings provided by “mobile network operators” (or MNOs), mobile money program managers, or financial institutions (or FIs). For example, “mobile money” may include the basic financial services offered by an MNO to predominantly underserved consumers in developing economies. Currently, the majority of mobile money programs are “closed-loop” offerings wherein the payment services are provided directly to merchants and end-users by the owner of the network without involving third-party financial institution intermediaries, and such programs have limited utility for consumers. Closed-loop payment networks can range in size from payment networks run by companies, such as the American Express Company, which issues payment cards directly to consumers and serves merchants directly, to individual entities that provide a payment mechanism to its customers. In contrast, “open-loop” payment networks, such as the BankNet® network operated by MasterCard International Incorporated, include multiple parties and operate through a system that connects two financial institutions—an issuer financial institution (or issuer) that issued the card to a cardholder, and an acquirer financial institution (or acquirer) that has a banking relationship with the merchant. The open-loop payment network manages information and the flow of value between the issuer financial institutions (FIs) and the acquirer FIs. In such open loop systems, the issuer FIs issue open-loop payment card accounts to consumers and have the responsibility for determining fees and many other payment card features.

As mentioned above, it would be desirable to provide interfaces and/or gateways to connect accounts (e.g., such as mobile money accounts provided by MNOs, which are operated as a closed-loop system) to payment card networks (e.g., such as the BankNet® network provided by MasterCard International Incorporated (MasterCard®), which are open-loop systems) to provide open-loop utility for consumers. As used herein, for illustrative purposes, the payment network may be referred to as the MasterCard® network; however, those skilled in the art, upon reading this disclosure, will appreciate that other payment networks may also be used with desirable results.

In some implementations, consumers need to establish a stored value account (or “SVA”) with the MNO or program manager. A mobile companion prepaid card is a low cost, un-embossed, un-personalized card issued by an agent instantly to a consumer, linked on the fly to the consumer's current SVA and, in some embodiments, authenticated by the consumer mobile personal identification number (or “mPIN”). In some embodiments, the consumer requests a mobile companion prepaid card at an agent location, and then registers for it by providing consumer information such as know-your customer (“KYC”) information to an agent and by agreeing to various terms and conditions. If all required consumer information is provided and validated by an issuer financial institution (FI), then the consumer is provided with a mobile companion prepaid card account. Consumers will maintain their existing SVA and all consumer life cycle management will be delivered through the consumer's mobile device.

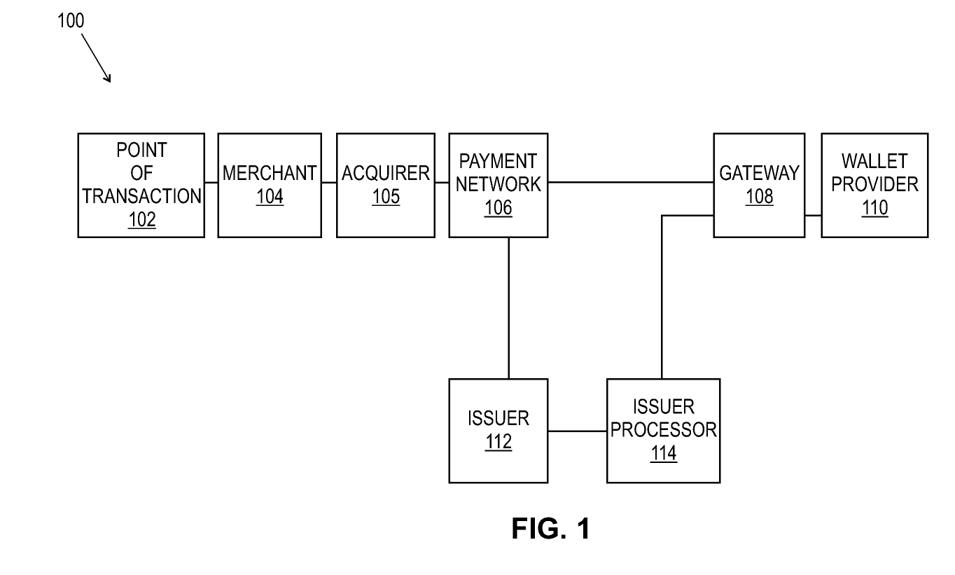

FIG. 1 illustrates a gateway transaction system 100 according to some embodiments. A point of transaction 102 (for example, a retail store or merchant website) for a consumer is shown, as are a merchant device 104 (for example, a point of sale (POS) terminal), an acquirer financial institution 105, a payment network 106, an issuer financial institution 112 with associated issuer processor 114, and pursuant to the present disclosure, a gateway 108 provided between a wallet provider 110 and the issuer processor 114. In some embodiments, the gateway 108 is also configured for data communications with the payment network 106 in accordance with one or more processes disclosed herein. Accordingly, pursuant to some embodiments, the gateway 108 is designed to provide a standardized method and interface for interconnecting a wide variety of wallet providers and issuer processors. Thus, although only one wallet provider 110 and one issuer processor 112 are shown, embodiments include a plurality of such wallet providers and issuer processors (which are associated with a plurality of issuer financial institutions). Such interconnection allows for a number of benefits. For example, the issuer processor 114 and the wallet provider 110, using features disclosed herein, are able to synchronize the consumer's or account holder's account balances and available funds to determine if a transaction should be authorized. Pursuant to some embodiments, the mobile companion prepaid card may operate as described in the co-pending, commonly-assigned U.S. Patent Application No. 61/768,249 (filed on Feb. 22, 2013), the contents of which are hereby incorporated by reference in their entirety for all purposes.

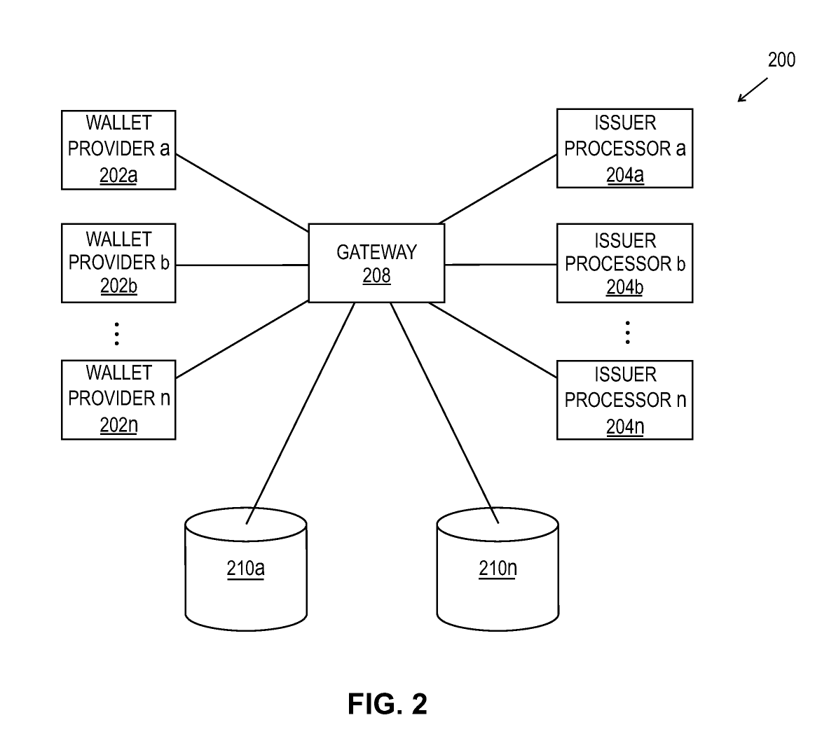

FIG. 2 is a block diagram depicting an embodiment of a gateway system 200 that may be provided pursuant to some embodiments. As shown, a gateway 208 may facilitate communication and interaction between a variety of entities, including, for example, a number of different wallet providers 202a-202n and a number of different issuer processors 204a-204n (which may be associated with different issuer FIs and/or other issuers) to synchronize information regarding current account balances and/or availability of funds in order to authorize a purchase transaction. Pursuant to some embodiments, the gateway 208 may be operated, for example, by an entity such as MasterCard International Incorporated, and may facilitate communication between the wallet providers and issuer processors. In some embodiments, the exchange of data between the plurality of wallet providers 202 and the plurality of issuer processors 204 is mediated by the gateway 208 to allow interoperability.

Pursuant to some embodiments, the gateway 208 includes or is operably connected to one or more databases 210a to 210n which in some embodiments store routing information and/or connectivity information for each of the entities 202a-n and 204a-n (the wallet providers and the issuer processors). The databases 210a to 210n may also store multi-entity flag information associated with consumer accounts that require gateway processing. In particular, when a transaction includes a multi-entity authorization flag then the gateway 208 will receive the transaction information from a payment network (not shown in FIG. 2) that is associated with a consumer account for processing. Thus, the use of such a multi-entity authorization flag defines a way for the payment network to intelligently identify particular transactions that require multi-entity authorization processing in no particular sequence, which transactions can be handled by the gateway 208.

In some embodiments, the gateway 208 does not function to store or process consumer specific data (e.g. payment card data and/or consumer profile data), but only function to route the data between the relevant entities. In addition, in some embodiments the database(s) 210a-210n do not store payment information and/or any logs relating to the authorization, clearing or settlement of transactions. However, in some implementations consumer specific data is processed, and transactions are logged so that reconciliation files and the like can be generated. Accordingly, the gateway 208 and the databases 210a-210n provide an intelligent routing system operable to forward messages between the entities involved in a transaction (which may include two or more entities) by reading and interpreting the message stream to initially determine the destination (or destinations), and then to forward a particular message to one or more appropriate destination(s). Pursuant to some embodiments, the access to the gateway 208 will be defined in one or more application programming interfaces (APIs) that help or guide the entities 202 and 204 (wallet providers and issuer processors) to connect to the platform. In general, APIs are sets of requirements or programming instructions that govern how one application talks to another. Thus, pursuant to some embodiments, an interface for updating the routing information and/or routing tables will be provided as new entities 202 and/or 204 are added or modified.

Accordingly, one or more of the databases 210a to 210n of the gateway platform may store the connectivity information between entities (for example, wallet providers 202 and the issuer processors 204 shown in FIG. 2) to facilitate the routing of data. Further, as additional wallet providers (such as MNOs that provide stored value accounts to consumers) and issuer FIs join or enroll with the gateway system, the gateway 208 allows for a common interface for adding those entities. Yet further, in some implementations the databases 210a to 210n store value added services (VAS) information that may be utilized, for example, by the gateway platform to conduct KYC information validation and/or anti-money laundering (AML) checks (and the like) on-behalf-off (OBO) other entities. Accordingly, the gateway 208 provides a common interface or messaging hub to seamlessly connect multiple entities for transaction processing and/or to provide OBO services.

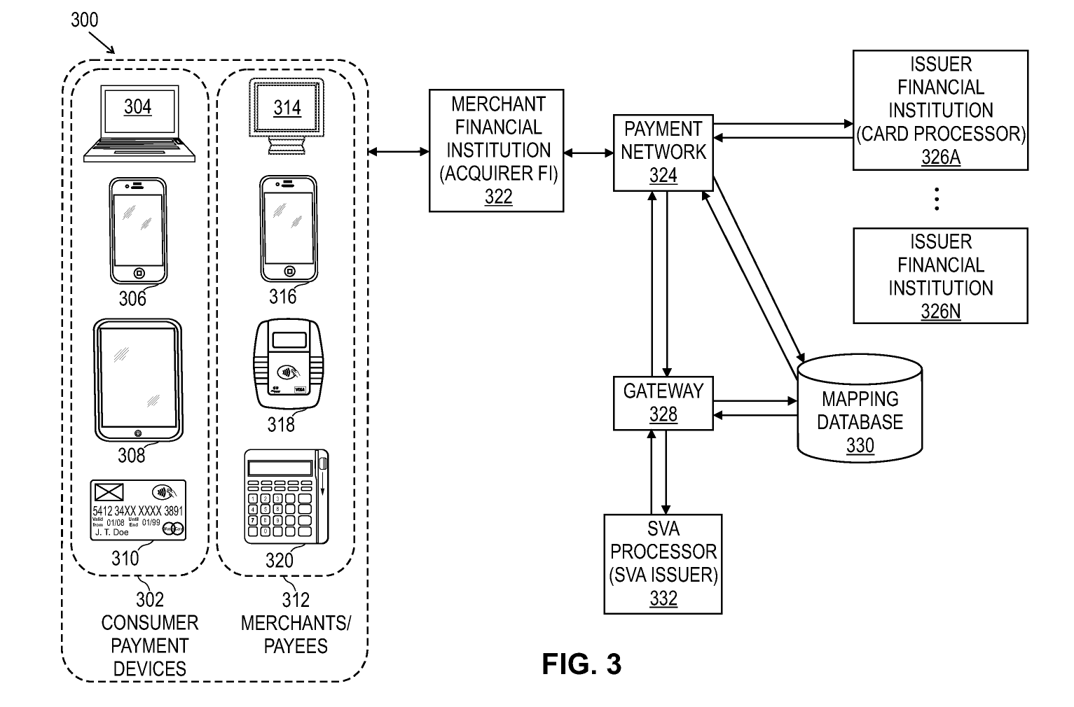

FIG. 3 is a block diagram of a payment gateway system 300 that accommodates multi-channel transactions by providing multi-lateral, real time synchronization of disparate payment account systems in accordance with some embodiments. It should be understood that the various components shown in FIG. 3 may be a subset of a larger system for providing real time synchronization between disparate payment account systems and for facilitating purchase transactions between consumers (users or account holders) and merchants, and/or for facilitating payment transactions between one or more financial institutions (FIs) such as acquirer and issuer banks. It should also be understood that, in some embodiments, issuing FIs and/or wallet providers may be required to enroll or register with the payment gateway system.

Referring to FIG. 3, a consumer or payer channel 302 may include various types of payment devices 304-310, which may include, but are not limited to, an end user's (account holder's) or a consumer's laptop computer 304, smartphone 306, tablet computer 308, and credit card or debit card 310 (which may be a magnetic stripe card or a contactless payment card that includes payment circuitry, for example, that has near-field communication (NFC) capability). A merchant channel or payee channel 312 may likewise include various types of merchant devices 314-320, which devices are capable of interacting with the end user or account holder payment devices. For example, the merchant devices may include, but are not limited to, a computer 314 hosting a merchant website, a merchant Smartphone 316, a merchant contactless card reader device 318 which may be associated, for example, with a point-of-sale (POS) device (not shown) at a merchant retail location, and a magnetic stripe card reader 320 which may also be associated with a point-of-sale (POS) device (not shown). It should be understood that other types of consumer payment devices (for example, a digital music player or personal digital assistant (PDA) including payment circuitry and a payment application) and other types of merchant devices (for example, a merchant tablet device) could be utilized.

Referring again to FIG. 3, the gateway system 300 also includes a merchant financial institution (or acquirer FI) 322 operable to communicate with any of the merchant devices 314 to 320. The acquirer FI 322 is also in communication with a payment network 324, which is configured for communications with a plurality of issuer FIs 326A to 326N, a payment gateway 328 and a mapping database 330. The gateway 328 is operable to communicate with a stored value account (SVA) processor 332 which may be a SVA issuer. It should be understood that, in practical embodiments of the payment gateway system 300 there may be a plurality of different merchant FIs, two or more payment networks, a gateway 328, two or more mapping databases 330, a plurality of SVA processors 332, and/or many different issuer FIs 326 (as shown).

An example of a merchant-initiated, multi-stage authorization and payment flow will now be described with reference to FIG. 3. During a purchase transaction involving a consumer and a merchant, the merchant utilizes one of the merchant devices 312 to receive payment information from one of the consumer payment devices 302 of an end user. The merchant device then formats and routes an authorization and/or payment request to the merchant processor (acquirer FI) 322, which includes passing payment credentials (in original form as provided by the payer) to the merchant processor. In some embodiments, the merchant processor FI 322 then applies standard business and/or transaction processing rules, formats a network authorization request, and then passes the original payment credentials to the payment network 324. The payment network 324 then queries the credential mapping database 330 by passing the payment credentials in original form as provided by the payer. The credential mapping database 330 maps the payment credentials of the consumer to stored data (which stored consumer credentials were obtained during an enrollment process), obtains the consumer's primary account number (e.g. a PAN), and adds a multi-entity authorization indicator or multi-entity flag, if required. Next, the credential mapping database transmits both the PAN and the multi-entity flag (if applicable) to the payment network 324.

The multi-entity authorization indicator exists in the credential mapping database for a particular consumer (or end user or account holder) when that consumer holds multiple payment accounts across disparate payment systems. In such a case, account balance synchronization must be provided across two or more authorization systems. For example, a consumer is attempting to pay for a purchase transaction with his or her Smartphone, which is associated with a closed loop account that is currently serviced by a digital stored value account (SVA) processor associated with an MNO. Thus, the system of record for the transaction is the digital SVA processor of the MNO. However, the same consumer had added an open loop instrument, such as a credit card account at an issuer bank, and thus the credit card processor of the issuer FI needs to authorize any transactions of that consumer even though it may not be the system of record. The payment gateway system 300 facilitates communications so that the digital SVA processor (of the MNO) and the card processor (of the issuer FI) are provided with the transaction data irrespective of the entity that acts as the system of record for a particular transaction. If either entity declines to authorize the transaction, then the transaction is declined. It should be understood that a particular consumer may hold three or more accounts that must all be synchronized when a transaction is initiated, and in such cases all of the entities involved must authorize the transaction (in no particular sequence) or else that transaction will be declined.

Thus, referring again to FIG. 3, the payment network 324 utilizes the consumer's PAN received from the credential mapping database to determine the appropriate issuer FI to communicate with regarding the transaction, appends the PAN and the multi-entity flag (if applicable) to the original authorization and/or payment request message, and then transmits the original authorization and/or payment request message to the appropriate card issuer FI 326A, which issued the consumer's payment card account. The card issuer FI 326A then applies standard business and processing rules, and on approval applies the debit or the credit to the end user's payment card account, or declines the authorization request as per standard business practices (i.e., business as usual or “BAU” practices).

In the case where the issuer FI approves the authorization request, the payment network 324 receives the authorization or payment approval and also recognizes that a multi-entity flag is set or included. In this case, the payment network 324 then routes the authorization/payment request including the multi-entity flag to the gateway 328 for further processing. The payment gateway 328 receives the authorization/payment request and also recognizes the presence of the multi-entity flag (or multi-entity authorization indicator). The payment gateway 328 then queries the credential mapping database 330 by transmitting various authorization message data which includes, but is not limited to, the original payment credentials and/or primary account number (e.g. PAN). The mapping database 330 receives the query and then maps the PAN to the appropriate SVA account number based on one or more of the data elements in the authorization/payment request that was received. The query may also include any other enrichment data elements or instructions (i.e., identifying the consumer wallet provider, a consumer wallet identifier such as an account number, and the like). The payment gateway 328 then logs the request and formats the authorization/payment request (or reformats the original authorization request) in the required standard defined for the SVA processor 332 that is associated with the SVA account number and/or the other data elements passed from the mapping database 330 (the enabler for value-added services (VAS)). The payment gateway 328 then transmits the formatted (or reformatted) authorization/payment request to the appropriate SVA processor 332.

The SVA processor 332 receives the formatted authorization/payment request and applies standard business and processing rules to make a determination concerning authorization or not, and on approval applies the correct debit or credit to the customer's SVA account (or declines the authorization request as per standard business practices, or BAU). The SVA processor 332 next transmits the authorization/payment response to the payment gateway 328 with the appropriate disposition (an approval or a decline) along with the customer's SVA account number. The payment gateway 328 receives the disposition response from the SVA processor 332, reformats the message data elements into the format required by the payment network 324, and then transmits the reformatted disposition response (an authorization or decline payment response) to the payment network 324.

If the payment network 324 receives an authorization/payment response from the mobile payment gateway 328 indicating that the SVA processor declined the transaction, then the payment network 324 generates a reversal message to “cancel” the authorization or approval previously received from the card issuer 326A. The payment network 324 transmits the reversal message to the card issuer 326A. Upon receiving the reversal message from the payment network 324, the card issuer 326A applies standard business and processing rules associated with reversal messages, and then transmits the reversal response to the payment network 324. The payment network then transmits a decline message to the acquirer FI (or merchant FI) 322, which then generates and transmits a decline message to the appropriate merchant device 312. A decline message may also be generated and transmitted to the consumer's mobile device, which decline message may include details concerning why the transaction was declined and by whom (for example, the transaction was declined by the issuer FI because of a lack of available credit, and/or was declined by the SVA processor due to an insufficient account balance).

However, if the SVA processor also approved the transaction, and the authorization/payment response from the payment gateway 328 was an approval, then the payment network 324 sends an authorization/payment approval response to the merchant FI 322. The merchant FI 322 then generates and routes an authorization/payment approval response to the appropriate merchant device 312. In addition, an authorization message may also be generated and transmitted to the consumer's mobile device.

The multi-lateral gateway system implementations disclosed herein do not require bi-lateral commercial agreements between SVA processors and card issuer processors for each type of payment product (which is typically required when establishing a new implementation). Negotiating and finalizing such bi-lateral agreements is a time consuming process that can slow down implementation and/or acceptance of consumer payment offerings. The presently disclosed gateway systems, apparatus and methods advantageously provide a centralized access mechanism with connectivity among participating entities, sharing of data among multiple sources, translation of data (such as account specific information), and formatting of data as specified by industry standards without the need for such commercial agreements. In addition, in some embodiments the overall process is controlled and monitored by a payment network. Furthermore, entities that enroll or register with the gateway system only need to connect and/or integrate with the gateway system once to have access to any other entity that is already connected to the system, which reduces and/or simplifies the time to market for all entities in the ecosystem. For example, a first credit card processor A, a second credit card processor B, a first digital SVA processor C, and a second SVA processor D all enroll with a gateway processor system. Thus, the credit card processor A has only one relationship, which is with the gateway system, but can support consumers who are served by both digital SVA processors C and D. Similarly, credit card processor B and digital SVA processors C and D also have established a single relationship with the gateway system and now each has access to multiple entities. In contrast, conventional systems require credit card processor A to have a bilateral agreement with each of the SVA processors C and D, and require credit card processor B to have bilateral agreements with SVA processors C and D.

Furthermore, the gateway systems described herein advantageously eliminates the need for a pre-defined system of record hierarchies, thus allowing each system of record to apply fully independent business and processing rules and procedures. In some embodiments, as disclosed herein a payment transaction includes a multiple-entity flag when that payment transaction must be authorized by multiple parties. When the multiple-entity flag is set, then that the purchase transaction will be successful only if it is authorized by a payment card issuer processor, a digital SVA processor, or some other combination or entities. If any one of the entities or parties declines the purchase transaction then a decline message is transmitted to the acquirer FI and/or to the consumer. Such gateway systems ensure that each party in the multi-entity scheme has the ability to independently create and adhere to their own business and processing rules. In particular, each entity or party is an independent entity and therefore a master-slave relationship does not exist. Each entity thus has the opportunity or right to approve or decline a particular purchase transaction of the consumer based on that entity's own rules and/or policies regardless of the payment channel or consumer payment device being utilized.

For example, a consumer uses his credit card to pay a merchant for a purchase transaction. The purchase transaction information is initially transmitted to the payment card processor via a merchant acquirer FI, and the payment card processor contacts the appropriate issuer FI which approves the transaction. However, since a multi-entity authorization flag was set, the purchase transaction information is also forwarded to a digital SVA processor associated with the consumer's mobile money account. In this example, the digital SVA processor checks the consumers stored value account and triggers a decline indication due to unavailability of funds to cover the purchase transaction. Thus, in this case the payment transaction is declined and the gateway system generates a reversal in real time of the initial approval by the payment card processor to maintain the integrity of the purchase transaction in a multiparty ecosystem.

In addition, gateway systems as disclosed herein enable real-time introduction of value added services and processes during payment flow. For example, anti-money laundering (AML) checking, Specially Designated Nationals (“SDN”) list checks and/or know your customer (KYC) checks may be conducted during processing of certain types of purchase transactions, and could affect the outcome or cause the system to request further information. Such AML checking, SDN checking and/or KYC checking typically depend upon international and local regulations, which may be available to and/or stored by the gateway system for application on the fly during a purchase transaction. Furthermore, various pieces of information relating to a particular consumer acquired during one or more purchase transactions could be collected and/or stored by the gateway system (for example, at the payment card processor and/or at the digital SVA processor) over a period of time. This information would then be available for application when needed for future purchase transactions. Accordingly, the gateway system allows value added services to be applied on the fly to purchase transactions, resulting in quick decisions based on one or more results of one or more value added services. Such decisions may include declining a particular purchase transaction, or requiring a consumer to supply additional and/or missing information (which may not be available at one or more of the participating entities). Thus, the real time injection of value added services provides data and access to services that could help comply with local and/or regional financial regulations, and enable real time decision making processes. The gateway system can also act as a central information gathering hub by obtaining data and/or information from multiple entities associated with a particular consumer, thus reducing the need to collect the same information from that consumer on multiple or numerous occasions (unless required by local laws or regulations). Furthermore, such processing helps reduce errors (such as unauthorized transactions), and increases the efficiency and/or speed of purchase transactions.

For example, global deployments of payment instruments require issuer financial institutions to gather or obtain “know-your-customer” (KYC) information from consumers. However, in some cases consumers already have existing payment accounts with stored value account (SVA) providers, and those SVA providers already have KYC information as required by law and/or regulation for those jurisdictions in which consumers perform transactions. Thus, if a particular consumer then opts to enroll or register for an open loop payment instrument, that consumer would potentially need to provide additional consumer information to, for example, an agent (i.e. a local representative of the digital SVA provider), who can then upload the information. But an advantage of the present payment gateway system 300 is that the payment gateway 328 acts as a central administrator and thus can perform initial checks for all required consumer information (including KYC information) and respond back to the agent with a request for any missing information. Thus, the payment gateway 328 can receive consumer information from an agent portal and then perform searches and/or database queries for any missing consumer information (and/or assimilate missing consumer data) because it has access to the data in the mapping databases and to data held by multiple entities that are members of the overall payment gateway system. Accordingly, the payment gateway can provide on-behalf-of (OBO) services for an issuer financial institution by locating, obtaining and then including, for example, KYC information for a particular consumer when that consumer applies to obtain a payment account from the issuer.

In addition, the gateway systems described herein may allow the standardization of KYC and/or AML requirements, despite the wide variety of such requirements in different jurisdictions. For example, as different countries have different KYC requirements, the gateway system may provide a universal standard KYC template that can be customized based on the local requirements. The standard KYC template may include, for example, the requirements that are common to all or substantially all jurisdictions, and then additional templates may be provided or added that include additional requirements as required by different jurisdictions (i.e., additional templates may be provided on a country by country basis). For example, an agent of a wallet provider enters the required KYC information or captures the information electronically and sends the information to the gateway. The gateway may then perform the initial checks or validations to make sure that relevant information has been populated as per local needs.

Additional value added services may be provided as well, such as consumer life cycle management and reporting, and/or other value added services. For example, the gateway 328 may expose one or more APIs or other functions or methods to facilitate an account update (such as an update of a primary account number (PAN) or other consumer information), to facilitate an account deletion, or to manage other consumer life cycle events (such as linking other PANs or accounts). Further, one or more methods or APIs or functions may be exposed to track and manage payment card and/or account expiration. For example, in some embodiments the gateway 328 keeps track of the expiry dates of consumer payment card accounts and creates exception reports concerning the cards and/or accounts that would expire in the next couple of months and sends one or more notifications, for example, to the wallet providers. The wallet provider can then inform the consumer of the impending expiry. The gateway 328 can also facilitate card renewal functions. For example, once the consumer requests a renewal, the gateway 328 can request any additional information as needed and forward this information to the appropriate issuer FI. Once the issuer FI receives this information, the gateway 328 could also facilitate the renewal process. The gateway 328 may also serve to monitor activity on a card or account and/or create an exception report that can be shared with the appropriate wallet provider to act upon. The wallet provider may choose to incentivize consumers to use their accounts through promotional methods or other initiatives as needed.

Other functions may also be facilitated by the gateway 328. For example, if a consumer needs to block a card or account, in some embodiments the gateway 328 may be configured to inform the appropriate issuer FI about the block request and subsequently unblock as needed. The gateway 328 can also facilitate the provision of balance inquiry data and account statements. For example, in some implementations the gateway 328 can retrieve information from one or more databases or fetch information from the system of record and forward account information to the appropriate wallet provider to be delivered to the consumer. The gateway 328 may also be configured to perform or facilitate a confirmation after each transaction. For example, upon successful authorization, the gateway 328 can generate a message that a wallet provider can forward to the consumer.

In each of these cases, the gateway 328 can be operated to keep track of information and to either initiate the appropriate process or help to retrieve information from the respective entities and deliver the appropriate messages to the appropriate or correct entities.

In some embodiments, the gateway system can be operated to provide enhanced or additional reporting to the consumer, to the wallet provider, and/or to an issuer FI. For example, one or more batch files or parameters may be defined for transaction reconciliation and settlement needs. For example, with regard to FIG. 2, the gateway 208 may create and distribute the batch files, for example, to an issuer processor 204 and wallet provider 202 associated with a customer or consumer on a prescheduled basis that contains details of all transactions (closed loop transactions can also be included).

Audit files may also be provided by the gateway 328. For example, audit files or requirements may be defined for different types of transactions, and such reports may be provided by the gateway 328 on a prescheduled basis. Customized reporting about transactions, users, and the like for each wallet provider and issuer FI combination may also be provided as needed (for example, on a daily, weekly, monthly, quarterly or other time basis). The gateway 328 can be leveraged to provide summary reports containing Key Performance Indicators (“KPIs”) or other information that can be distributed to the wallet providers and/or to the issuer FIs. For example, KPIs could be the number of transactions, the amount transacted, or the like information.

In some embodiments, the gateway system may be operated to create transaction reconciliation and settlement files. For example, this may include matching data between authorization and settlements, any adjustments such as tips (for example, on restaurant checks), identifying both closed loop and open loop transactions and providing the complete picture to the wallet provider or issuer processor based on the entity that plays the role of system of record.

In some implementations, the gateway keeps logs of all transactions involving participating entities as authorization messages flow between the entities. This information could include, but not limited to, data identifying: a transaction_id, a transaction_type (e.g., a purchase, etc.), a transaction amount, a transaction currency, a transaction date and/or time, a merchant identifier, or the like. In addition, the gateway may be used to facilitate transactions such as reversals, refunds, chargebacks and fraud management.

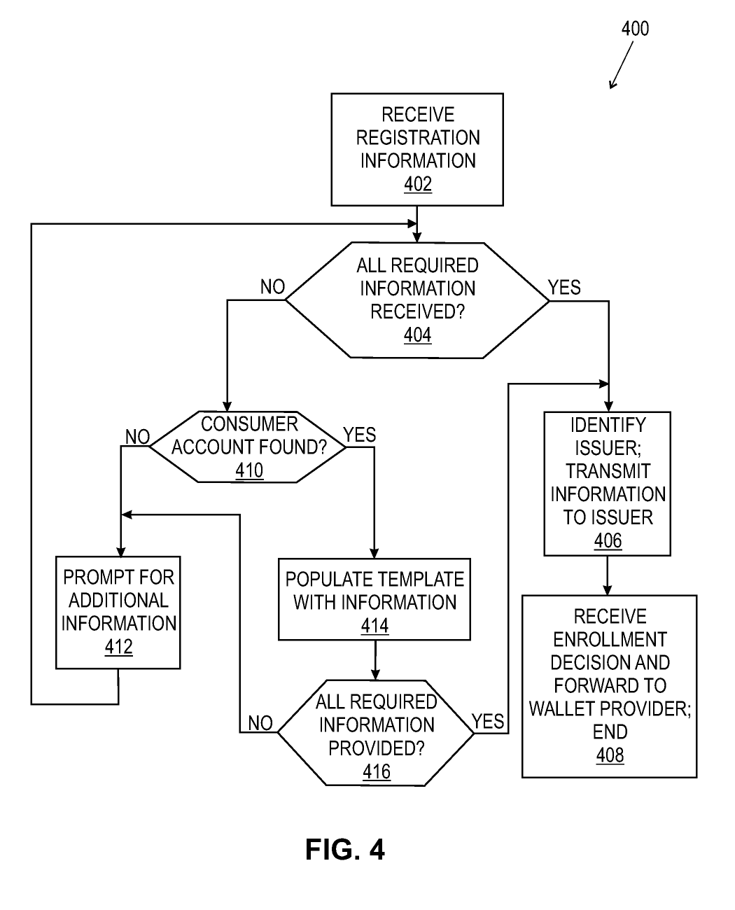

FIG. 4 is a flowchart 400 of a consumer registration or enrollment process according to some embodiments. Thus, in some embodiments account registration methods may be supported by the gateway system 200 and/or gateway system 300 of FIGS. 2 and 3. For example, the gateway 208 may expose one or more APIs that may be adopted by one or more wallet providers 202 and/or issuer processors 204 to enable an agent and/or a consumer to register or enroll an account. Thus, referring to FIG. 4, the gateway receives 402 consumer enrollment information for providing a mobile companion prepaid card to the consumer, which enrollment information may originate from a portal or system operated by an agent of a wallet provider. The agent may have a portal and/or system where he or she enters consumer information to start the registration or enrollment process. Such consumer information includes “know your customer” (KYC) information and possibly additional information as required by local regulation(s). In some embodiments, the KYC information or data is input by the mobile wallet agent into a standard template, and further information may be input into one or more additional templates that may have been selected or provided by the gateway based on the location of the consumer as per local requirements. In some implementations, the gateway may append one or more customized templates to a standard template (based on the location of the consumer) to generate a customized template which is then transmitted to the portal of the mobile wallet agent for use in enrolling the consumer or customer.

Referring again to FIG. 4, the gateway next checks or validates 404 the received KYC information and/or any additional required information for completeness to ensure that all the required consumer data has been provided as per the local requirements. For example, in checking the provided KYC information, the gateway may check for an indication from the consumer that he or she agreed to terms and conditions of the prepaid card provider. If all the required and/or relevant consumer information is present, then the gateway identifies 406 the appropriate issuer FI or issuer processor (for example, by utilizing a database look-up process) and transmits 406 the information (including the KYC data) to that issuer FI. The issuer FI may then validate and/or check the consumer's KYC information, compare the provided information to Office of Foreign Asset Control (“OFAC”) information, and conduct Specially Designated Nationals (“SDN”) list checks. Thus, the issuer determines the eligibility of the consumer to obtain the account and returns its decision to the gateway prior to prepaid card activation. (As part of its enforcement efforts, OFAC publishes an SDN list that includes individuals and companies owned or controlled by, or acting for or on behalf of, targeted countries. It also lists individuals, groups, and entities, such as terrorists and narcotics traffickers designated under programs that are not country-specific. Collectively, such individuals and companies are called “Specially Designated Nationals” or “SDNs,” their assets are blocked, and U.S. persons are generally prohibited from dealing with them.)

Next, the gateway next receives 408 the decision from the issuer (to either provision a mobile companion prepaid card to the consumer or not), and forwards that decision to the wallet provider, and the process (from the point of view of the gateway) then ends. It therefore should be understood that the wallet provider may require the consumer to participate in further process steps (not shown) including, for example, utilizing his or her mobile device to confirm the consumer's registration and to initiate an activation process to enable the mobile companion prepaid card to be used to conduct purchase transactions and/or payment transactions. For example, an SMS (a text message) or other type of message may be transmitted to the consumer's mobile device requesting the consumer's approval to activate the account. In some implementations, the message prompts the consumer to authenticate using an mPIN of his or her choice. Upon successful authentication by the consumer, the mobile companion prepaid card is activated and ready to be used at a merchant's point-of-sale terminal (“POS”), or to withdraw cash from an ATM machine, or to perform e-commerce transactions.

Referring again to FIG. 4, if in step 404 not all of the required consumer information has been provided, then the gateway processor determines 410 if the consumer had already registered for a payment account, for example, by querying the mapping database 330 (See FIG. 3) using some or all of the consumer information provided. If not, then the gateway transmits 412 a prompt to the agent portal for the missing information and/or additional information. If in response to the prompt it is found in step 404 that now all the missing data has been provided, then processing continues with step 406 as explained above. But if in step 410 a pre-existing consumer account is found, then the gateway populates 414 the payment account application template with information from the pre-existing account. If it is found in step 416 that all of the required information is now included, then processing continues with step 406 as explained above. However, if information is still found to be missing in step 416, then the gateway transmits 412 a prompt to the agent portal for the missing information and/or additional information and processing continues in such manner until all of the information is received. However, if a predetermined threshold number corresponding to, for example, a maximum number of prompts that can be made to obtain the required consumer information is reached without receiving the missing data, then an enrollment failure message may be transmitted to the agent's portal and/or to the consumer's mobile device, and in this case the process then ends without enrolling the customer.

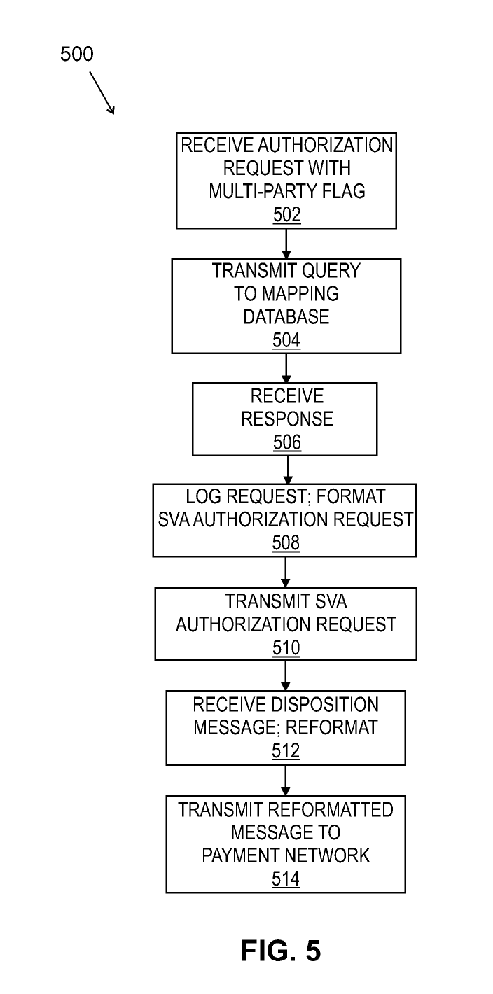

FIG. 5 is a flowchart 500 illustrating a gateway multi-channel transaction process in accordance with some embodiments. In particular, a gateway server computer or gateway processor (which can be referred to as a “payment gateway”) receives 502 a transaction authorization request from a payment network that includes a multi-entity flag or multi-party authorization indicator. In this case, the payment network had already transmitted an authorization request to the appropriate issuer FI (based on information associated with the transaction data) and received a positive response (an authorization) from that issuer FI, but then recognized that at least one other entity must also authorize the transaction before it is approved for payment. Accordingly, after receiving the transaction authorization request, the payment gateway transmits 504 a query to a credential mapping database that includes various authorization message data such as, but not limited to, the original payment credentials of the consumer and/or the PAN (primary account number) of the issuer of record. The payment gateway next receives 506 a response from the credential mapping database, which response includes an SVA account number and other enrichment data elements or instructions. The data provided in the response results from the mapping of the PAN to the appropriate SVA account number of the consumer (based on one or more of the data elements in the authorization/payment request).

Referring again to FIG. 5, the payment gateway next logs 508 the authorization request and then formats it into an SVA authorization request (or SVA payment request). The payment gateway forwards the authorization request to the particular SVA processor that is associated with the SVA account number and/or the other data elements received from the mapping database (the enabler for value-added services (VAS)). The payment gateway then transmits 510 the correctly formatted SVA authorization request to the appropriate SVA processor. The SVA processor receives the SVA authorization request (or payment request) and applies standard business and processing rules, and may also apply its own business rules to generate a transaction disposition response message. (In the case of transaction approval the SVA processor will apply the correct debit or credit to the customer's SVA account.) Thus, the payment gateway receives 512 a disposition response message (which is either an approval or decline response from the SVA processor), and then reformats the disposition response message into the format required by the payment network. The payment gateway then transmits 514 the reformatted disposition response message (which may be an approval message or a decline message) to the payment network for further processing. The payment gateway therefore acts as an intermediary between disparate payment systems to ensure that proper synchronization between a consumer's disparate payment accounts occurs for any particular transaction.

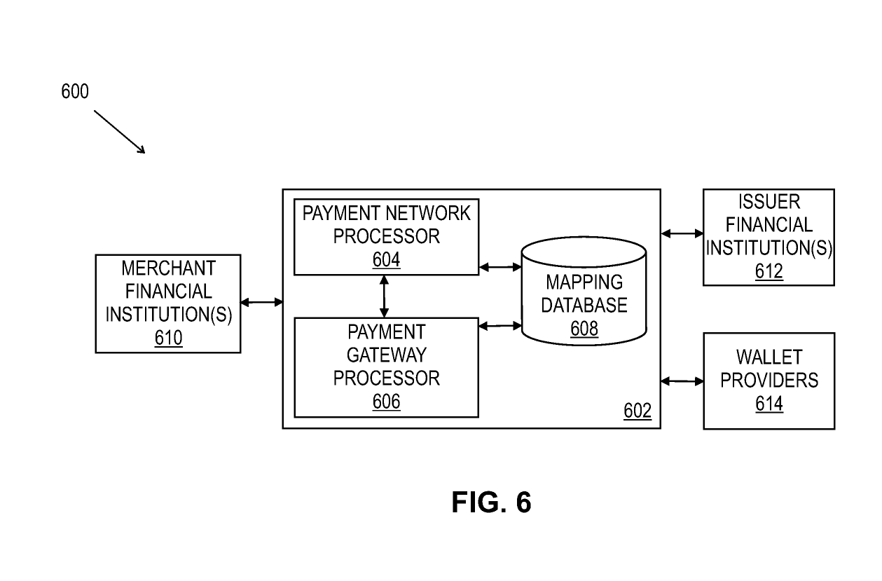

FIG. 6 is a block diagram of a payment gateway system 600 according to some embodiments. In particular, a gateway computer system 602 includes at least a payment network processor 604 operably connected to a gateway processor 606, which are both operably connected to a mapping database 608. The gateway computer system 602 is operable to communicate with a plurality of merchant financial institutions 610, issuer financial institutions 612, and wallet providers 614. The computer system 602 is configured to function according to the methods described herein to synchronize two or more disparate or different end user accounts during processing of a purchase transaction or payment transaction. In some embodiments, the gateway computer system 602 is owned and/or operated by a payment processing entity such as MasterCard International Incorporated, the assignee of the present application.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a payment network from a merchant acquirer processor, an authorization request for a consumer transaction, the authorization request comprising original payment credentials of the consumer;
transmitting, by the payment network to a credential mapping database, a query comprising the consumer's payment credentials;
receiving, by the payment network from the credential mapping database, a response comprising a primary account number (PAN) of the consumer and a multi-entity flag;
transmitting, by the payment network based on the PAN, the authorization request to an issuer financial institution associated with a payment card account of the consumer;
receiving, by the payment network, an approval response of the transaction from the issuer financial institution;
routing, by the payment network, the authorization request and the multi-entity flag to a payment gateway to forward to an appropriate stored value account (SVA) processor associated with a wallet provider;
receiving, by the payment network from the payment gateway, a disposition message indicating approval of the transaction by the SVA processor; and
transmitting, by the payment network, an authorization response to the merchant acquirer processor.

2. The method of claim 1, further comprising transmitting the authorization response to a consumer mobile device associated with the PAN.

3. The method of claim 1, further comprising, subsequent to routing the authorization request to the payment gateway:
receiving, by the payment network form the payment gateway, a disposition message indicating a decline of the transaction by the SVA processor;
generating, by the payment network, a reversal message to cancel the approval response of the transaction received from the issuer financial institution;
transmitting, by the payment network, the reversal message to the issuer financial institution;
receiving a reversal response from the issuer financial institution; and
transmitting, by the payment network, a decline message to the merchant acquirer processor.

4. The method of claim 3, further comprising transmitting the decline message to the consumer's mobile device associated with the PAN.

5. The method of claim 3, wherein the decline message comprises details concerning why the transaction was declined and by which entity.

6. A non-transitory computer readable medium storing instructions configured to cause a processor to:
receive an authorization request for a transaction from a merchant acquirer processor, the authorization request comprising original payment credentials of the consumer;
transmit a query comprising the consumer's payment credentials to a credential mapping database;
receive a response from the credential mapping database comprising a primary account number (PAN) of the consumer and a multi-entity flag;
transmit, based on the PAN, the authorization request to an issuer financial institution associated with a payment card account of the consumer;
receive an approval response of the transaction from the issuer financial institution;
route the authorization request and the multi-entity flag to a payment gateway to forward to an appropriate stored value account (SVA) processor associated with a wallet provider;
receive a disposition message from the payment gateway indicating approval of the transaction by the SVA processor; and
transmit an authorization response to the merchant acquirer processor.

7. The non-transitory computer readable medium of claim 6, further comprising instructions configured to cause the processor to transmit the authorization response to a consumer mobile device associated with the PAN.

8. The non-transitory computer readable medium of claim 6, further comprising, subsequent to the instructions for routing the authorization request to the payment gateway, instructions configured to cause the processor to:
receive a disposition message from the payment gateway indicating a decline of the transaction by the SVA processor;
generate a reversal message to cancel the approval response of the transaction from the issuer financial institution;
transmit the reversal message to the issuer financial institution;
receive a reversal response from the issuer financial institution; and
transmit a decline message to the merchant acquirer processor.

9. The non-transitory computer readable medium of claim 8, further comprising instructions configured to cause the processor to transmit the decline message to the consumer's mobile device associated with the PAN.

10. The non-transitory computer readable medium of claim 8, wherein the instructions for transmitting the decline message comprise details concerning why the transaction was declined and by which entity.

11. A system comprising:
a plurality of stored value account (SVA) processors associated with wallet providers;
a plurality of issuer processors;
a payment network;
a payment gateway operably connected to the plurality of SVA processors, to the plurality of issuer processors and to the payment network; and
at least one credentials database operably connected to the payment gateway and to the payment network, wherein the at least one credentials database stores connectivity information and value added services information;
wherein the payment network operates to:
receive an authorization request for a consumer transaction from a merchant acquirer processor, the authorization request comprising original payment credentials of the consumer;
transmit a query comprising the consumer's payment credentials to a credential mapping database;
receive a response from the credential mapping database comprising a primary account number (PAN) of the consumer and a multi-entity flag;
transmit, based on the PAN, the authorization request to an issuer financial institution associated with a payment card account of the consumer;
receive an approval response of the transaction from the issuer financial institution;
route the authorization request and the multi-entity flag to the payment gateway to forward to an appropriate stored value account (SVA) processor associated with a wallet provider;
receive a disposition message from the payment gateway indicating approval of the transaction by the SVA processor; and
transmit an authorization response to the merchant acquirer processor.

12. The system of claim 11, wherein the payment network, subsequent to routing the authorization request with the multi-entity flag to the payment gateway:
receives a disposition message from the payment gateway indicating a decline of the transaction by the SVA processor;
generates a reversal message to cancel the approval response of the transaction from the issuer processor;
transmits the reversal message to the issuer processor;
receives a reversal response from the issuer processor; and
transmits a decline message to the merchant acquirer processor.

13. A method for maintaining consumer account balance synchronization between disparate payment account systems, comprising:
receiving, by a payment gateway from a payment network, a transaction authorization request comprising authorization message data including a multi-entity flag;
transmitting the authorization message data to a credentials mapping database;
receiving, by the payment gateway from the credentials mapping database, a response comprising a consumer's stored value account (SVA) number;
generating, by the payment gateway, an SVA authorization request;
transmitting, by the payment gateway based on the SVA account number, the SVA authorization request to an SVA processor associated with a wallet provider;
receiving, from the SVA processor, a disposition response; and
transmitting, by the payment gateway, a purchase transaction authorization message to the payment network when the disposition response from the SVA processor is a purchase transaction authorization.

14. The method of claim 13, wherein the authorization message comprises at least one of original payment credentials of the consumer and a primary account number (PAN) of the issuer of record.

15. The method of claim 13, wherein the response from the credential mapping database further comprises enrichment data elements.

16. The method of claim 13, further comprising, subsequent to receiving the response, logging the authorization request.

17. The method of claim 13, further comprising, prior to transmitting the purchase transaction authorization message:
reformatting the disposition response message into a purchase transaction authorization message in a format required by the payment network; and
transmitting, by the payment gateway, the reformatted disposition response message to the payment network.

18. The method of claim 13, wherein generating the SVA authorization request comprises formatting the authorization request based on at least one of information regarding the required standard defined for the SVA processor associated with the SVA account number and the other data elements received from the mapping database.

19. The method of claim 13, further comprising, subsequent to receiving the disposition response, transmitting a purchase transaction denied message to the payment network by the payment gateway when the disposition response is a purchase transaction denied message.

20. The method of claim 13, further comprising:
receiving, by the payment gateway, value added information from at least one entity concerning consumer payment card accounts;
storing, by the payment gateway, the value added information in at least one mapping database; and
providing, by the payment gateway, value added processing on the fly to the transaction for at least one entity based on the value added information stored in the at least one mapping database.

21. The method of claim 20, wherein the value added information comprises at least one of know your customer (KYC) information, anti-money laundering (AML) information, and Specially Designated Nationals (“SDN”) information.

22. The method of claim 13, further comprising:
receiving, by the payment gateway, value added information from at least one entity concerning consumer payment card accounts;
storing, by the payment gateway, the value added information in at least one mapping database; and
providing, by the payment gateway, value added processing regarding consumer payment accounts.

23. The method of claim 22, wherein providing the value added processing comprises at least one of facilitating consumer account updates, facilitating consumer account deletions, and facilitating management of consumer account life cycle events.

24. A non-transitory computer readable medium storing instructions configured to cause a payment gateway to:
receive a transaction authorization request from a payment network, the transaction authorization request comprising authorization message data including a multi-entity flag;
transmit the authorization message data to a credentials mapping database;
receive from the credentials mapping database, a response comprising a consumer's stored value account (SVA) number;
generate an SVA authorization request;
transmit, based on the SVA account number, the SVA authorization request to an SVA processor associated with a wallet provider;
receive a disposition response from the SVA processor; and
transmit a purchase transaction authorization message to the payment network when the disposition response from the SVA processor is a purchase transaction authorization.

25. The non-transitory computer readable medium of claim 24, further comprising, prior to the instructions for transmitting the purchase transaction authorization message, instructions configured to cause the payment gateway to:
reformat the disposition response message into a purchase transaction authorization message in a format required by the payment network; and
transmit the reformatted disposition response message to the payment network.

26. The non-transitory computer readable medium of claim 24, further comprising instructions configured to cause the payment gateway to:
receive value added information from at least one entity concerning consumer payment card accounts;
store the value added information in at least one mapping database; and
provide value added processing on the fly to the transaction for at least one entity based on the value added information stored in the at least one mapping database.

27. The non-transitory computer readable medium of claim 26, wherein the value added information comprises at least one of know your customer (KYC) information, anti-money laundering (AML) information, and Specially Designated Nationals (“SDN”) information.

28. The non-transitory computer readable medium of claim 24, further comprising instructions configured to cause the payment gateway to:
receive value added information from at least one entity concerning consumer payment card accounts;
store the value added information in at least one mapping database; and
provide value added processing regarding consumer payment accounts.

29. The non-transitory computer readable medium of claim 28, wherein the instructions for providing the value added processing comprises instructions configured to cause the payment gateway to facilitate at least one of consumer account updates, consumer account deletions, and consumer account life cycle events.

30. A system comprising:
a plurality of stored value account (SVA) processors associated with wallet providers;
a plurality of issuer processors;
a payment network;
a payment gateway operably connected to the plurality of SVA processors, to the plurality of issuer processors and to the payment network; and
at least one credentials database operably connected to the payment gateway and to the payment network, wherein the at least one credentials database stores connectivity information and value added services information;
wherein the payment gateway:
receives a transaction authorization request from a payment network, the transaction authorization request comprising authorization message data including a multi-entity flag;
transmits the authorization message data to a credentials mapping database;
receives from the credentials mapping database, a response comprising a consumer's stored value account (SVA) number;
generates an SVA authorization request;
transmits, based on the SVA account number, the SVA authorization request to an SVA processor associated with a wallet provider;
receives a disposition response from the SVA processor; and
transmits a purchase transaction authorization message to the payment network when the disposition response from the SVA processor is a purchase transaction authorization.
